(19) United States
(12) Patent Application Publication
(10) Pub. No.: US 2023/0064836 A1
(43) Pub. Date: Mar. 2, 2023

(54) INSPECTION SYSTEM AND INSPECTION METHOD FOR SECONDARY BATTERY

(71) Applicant: KABUSHIKI KAISHA TOSHIBA, Tokyo (JP)

(72) Inventor: Kazuyoshi UEDA, Yokohama (JP)

(73) Assignee: KABUSHIKI KAISHA TOSHIBA, Tokyo (JP)

(21) Appl. No.: 17/818,424

(22) Filed: Aug. 9, 2022

(30) Foreign Application Priority Data
Aug. 27, 2021 (JP) 2021-139078

(51) Int. Cl. G06T 7/00; G06T 7/90

(52) U.S. Cl. CPC G06T 7/0004; G06T 7/90; G01N 2021/8887

(57) ABSTRACT

According to one embodiment, an inspection system for a secondary battery includes an image sensor, a detector, and an inspection processor. The image sensor captures an image of an electrode structure of a secondary battery. The electrode structure includes an electrode and a fiber layer formed on a surface of the electrode. The electrode includes a current collector and an active material layer. The detector detects a color in data of the image captured with the image sensor. The inspection processor inspects a residue of an organic material in the fiber layer, based on the color detected with the detector.

### CROSS-REFERENCE TO RELATED APPLICATIONS

This application is based upon and claims the benefit of priority from the Japanese Patent Application No. 2021-139078, filed Aug. 27, 2021, the entire contents of which are incorporated herein by reference.

### FIELD

Embodiments described herein relate generally to an inspection system and an inspection method for a secondary battery.

### BACKGROUND

In a secondary battery such as a lithium secondary battery, a porous separator is used so as to avoid a contact between a positive electrode and a negative electrode. For example, a layer of nano-sized organic fibers is used as a separator.

A layer of organic fibers formed on electrodes in a secondary battery may have various defects at the time of manufacture. It is desired that such defects of a layer of organic fibers can be inspected at the stage of manufacture.

### BRIEF DESCRIPTION OF THE DRAWINGS

FIG. 1 is a diagram showing an example of an inspection system for a secondary battery according to an embodiment.

FIG. 2A is a cross-sectional view showing a configuration of an electrode sheet.

FIG. 2B is a diagram showing a state of the electrode sheet at the time of inspection of a fiber layer.

FIG. 3 is a diagram showing a hardware configuration of an inspection apparatus.

FIG. 4 is a flowchart illustrating an operation of the inspection apparatus.

FIG. 5 is a flowchart illustrating defect detection processing according to an embodiment.

FIG. 6A is a diagram showing an inspection region.

FIG. 6B is a graph of a value of the brightness along the line L shown in FIG. 6A.

FIG. 7A is a diagram showing an example of a display of a residue defect.

FIG. 7B is a diagram showing an example of a display of a residue defect.

### DETAILED DESCRIPTION

In general, according to one embodiment, an inspection system for a secondary battery includes an image sensor, a detector, and an inspection processor. The image sensor captures an image of an electrode structure of a secondary battery. The electrode structure includes an electrode and a fiber layer formed on a surface of the electrode. The electrode includes a current collector and an active material layer. The detector detects a color in data of the image captured with the image sensor. The inspection processor inspects a residue of an organic material in the fiber layer, based on the color detected with the detector.

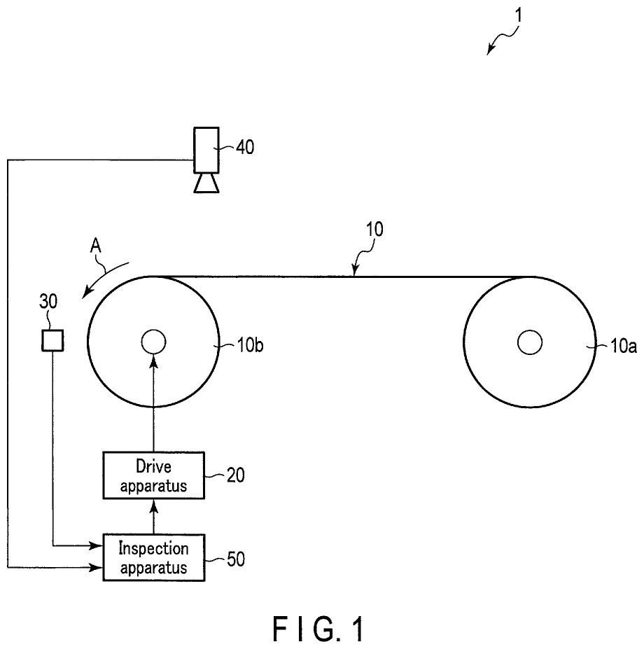

Hereinafter, embodiments will be described with reference to the drawings. FIG. 1 is a diagram showing an example of an inspection system for a secondary battery according to an embodiment. An inspection system 1 is a system for inspecting a defect of a fiber layer formed in an electrode sheet 10 manufactured at the stage of manufacturing a secondary battery. The electrode sheet 10 manufactured in the manufacturing stage is put into the inspection system 1 by a roller 10a and conveyed in a direction indicated by the arrow A by a roller 10b. The rollers 10a and 10b are configured to be rotated by, for example, a motor. The electrode sheet 10 forms a battery of an electrode structure included in a secondary battery.

A drive apparatus 20 has drive circuitry for driving the rollers 10a and 10b. The drive circuitry, for example, generates a drive current for driving the motor of the rollers 10a and 10h and supplies the generated drive current to the rollers 10a and 10h.

An encoder 30 is installed near the roller 10b and detects the rotation amount of the roller 10b. The encoder 30 outputs the rotation amount of the roller 10b to an inspection apparatus 50 as a conveyance amount of the electrode sheet 10. The encoder 30 is, for example, an optical encoder which detects the rotation amount of the roller 10b by counting the optical pattern given to the roller 10b. The encoder 30 need not necessarily be an optical encoder. The encoder 30 may be installed near the roller 10a instead of near the roller 10b.

An image sensor 40 is installed above the electrode sheet 10 and captures an image of the electrode sheet 10 to generate imaging data related to the electrode sheet 10. The image sensor 40 may be an image sensor of a complementary metal oxide semiconductor (CMOS) type or an image sensor of a charge coupled device (CCD) type. The image sensor 40 outputs the generated imaging data to the inspection apparatus 50. Herein, the image sensor 40 is a line sensor having pixels arrayed along the width direction of the electrode sheet 10 intersecting the conveyance direction of the electrode sheet 10. The image sensor 40 may have a single line or multiple lines. On the other hand, the pixels of the image sensor 40 in the width direction are preferably arrayed with a width equal to or greater than the width of the electrode sheet 10. Each of the pixels of the image sensor 40 is configured by three sub-pixels in red (R), green (G), and blue (B). Namely, the image sensor 40 is configured to be able to generate a color image. The imaging frame rate of the image sensor 40 is preferably synchronized with the conveyance speed of the electrode sheet 10.

The inspection apparatus 50 inspects the electrode sheet 10 for the presence or absence of a defect as well as the position of a defect based on the conveyance amount of the electrode sheet 10 input from the encoder 30 and the image of the electrode sheet 10 input from the image sensor 40. The inspection apparatus 50 may be configured by a computer, such as a personal computer, including a processor.

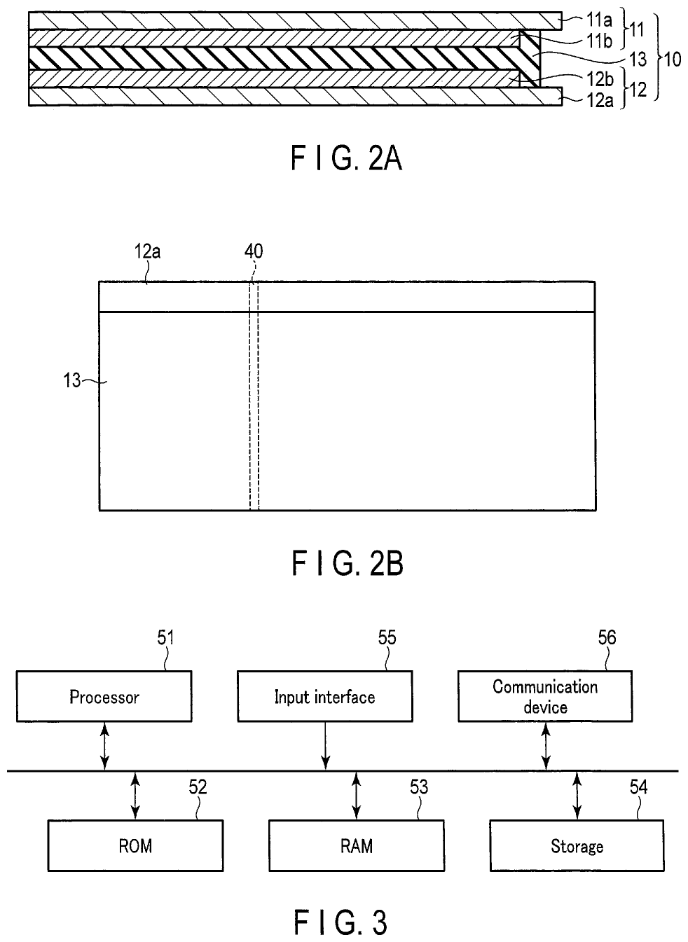

FIG. 2A is a cross-sectional view showing the configuration of the electrode sheet 10. The electrode sheet 10 is a sheet member including a positive electrode 11 and a negative electrode 12. The positive electrode 11 and the negative electrode 12 are insulated from each other by a fiber layer 13 as an insulator that includes organic fibers. The fiber layer 13 is not an independent film and is supported by the negative electrode 12. The electrode sheet 10 may be cut into an appropriate length to form a battery of an electrode structure of a secondary battery.

The negative electrode 12 is configured by providing a negative electrode active material layer 12b on a surface of a negative electrode current collector 12a. Likewise, the positive electrode 11 is configured by providing a positive electrode active material layer 11b on a surface of a positive electrode current collector 11a. A foil made of metal such as aluminum is used as the negative electrode current collector 12a and the positive electrode current collector 11a. The negative electrode active material layer 12b is formed using a slurry containing a negative electrode active material, a negative electrode conductive agent, and a binder. The positive electrode active material layer lib is formed using a slurry containing a positive electrode active material, a positive electrode conductive agent, and a binder.

For example, lithium titanate may be used as the negative electrode active material. Examples of the lithium titanate include Li₄₊ₓTi₅O₁₂ (0<x≤3) having a spinel structure and. Li_{2+y}Ti₃O₇ (0≤y≤3) having a ramsdellite structure. An average particle size of the primary particles of the negative electrode active material is preferably in a range of 0.001 μm to 1 μm. The shape of the particles may be a granular shape or a fibrous shape. In the case of the fibrous shape, the fiber diameter is preferably 0.1 μm or less.

For example, acetylene black, carbon black, graphite, etc., may be used as the negative electrode conductive agent. For example, polytetrafluoro-ethylene (PTFE), polyvinylidene fluoride (PVdF), fluorine rubber, styrene-butadiene rubber, etc., may be used as the binder for binding the negative electrode active material and the negative electrode conductive agent.

A general lithium transition metal composite oxide may be used as the positive electrode active material. For example, LiCoO₂, LiNi₁₋ₓCoₓO₂ (0<x<0.3), LiMnₓNi_{y}Co_{z}O₂ (0<x<0.5, 0<y<0.5, 0≤z<0.5), LiMn₂₋ₓMdO₄ (M is Li, Mg, Co, Al, or Ni, 0<x<0.2), LiMPO₄ (M is Fe, Co, or Ni), etc., may be used.

For example, carbonaceous materials such as acetylene black, carbon black, and graphite may be used as the positive electrode conductive agent. For example, polytetrafluoro-ethylene (PTFE), polyvinylidene fluoride (PVdF), fluorine rubber, etc., may be used as the binder.

The fiber layer 13 is lithium-ion conductive and acts as an electrically insulating separator. The fiber layer 13 may be directly formed on a surface of the negative electrode 12 or the positive electrode 11 by using a solution of an organic material as a basic material and using, for example, an electrospinning method, an inkjet method, a jet dispenser method, a spray coating method, or the like. Herein, the fiber layer 13 also covers the edges of the negative electrode active material layer 12b of the negative electrode 12 and the positive electrode active material layer 11b of the positive electrode 11. On the other hand, the edges of the negative electrode current collector 12a of the negative electrode 12 and the positive electrode current collector 11a of the positive electrode 11 are not covered with the fiber layer 13 and project from the fiber layer 13. Such a configuration suppresses generation of a short circuit caused by the misalignment of the electrode surfaces and the cutting of the electrodes or the current collectors. Moreover, since the edges of the electrodes are covered with an insulator including the fiber layer 13, generation of a short circuit at the edges is avoided, allowing for enhancement of the safety of the battery. Covering the edges of the electrodes with an insulator including the fiber layer 13 also leads to improvement of self-discharge characteristics.

For example, a solution prepared by dissolving an organic material in a solvent is used for electrospinning. The organic material can be selected from, for example, the group consisting of polyamide imide, polyamide, polyolefin, polyether, polyimide, polyketone, polysulfone, cellulose, polyvinyl alcohol (PVA), and polyvinylidene fluoride (PVdF). Examples of the polyolefin include polypropylene (PP) and polyethylene (PE).

FIG. 2B is a diagram showing a state of the electrode sheet 10 at the time of inspection of the fiber layer 13. FIG. 2B shows a state of the electrode sheet 10 viewed from the side closest to the image sensor 40 in FIG. 1. In FIG. 2B, it is assumed that the fiber layer 13 is formed on the negative electrode 12. In the embodiment, when the formation of the fiber layer 13 is completed in the manufacturing stage, the electrode sheet 10 is put into the inspection system 1 via the roller 10a before the positive electrode 11 is formed. Namely, the electrode sheet 10 is put in such that the fiber layer 13 is exposed when viewed from the image sensor 40. The image sensor 40 captures an image of the electrode sheet 10 from the side closest to the fiber layer 13 at a frame rate synchronized with the conveyance speed of the electrode sheet 10. The image sensor 40 then outputs the imaging data to the inspection apparatus 50. Imaging data obtained when the image sensor 40 is a single-line sensor is data corresponding to a single line of the electrode sheet 10, in which each of the pixels has brightness values of R, G, and B. In each single line, the imaging data captured with the image sensor 40 includes a first region of the electrode 12 and a second region of the fiber layer 13.

FIG. 3 is a diagram showing a hardware configuration of the inspection apparatus 50. The inspection apparatus 50 may be a terminal device of various types, such as a personal computer (PC) or a tablet terminal. As shown in FIG. 3, the inspection apparatus 50 includes, as hardware, a processor 51, a ROM 52, a RAM 53, a storage 54, an input interface 55, a communication device 56, and a display 57.

The processor 51 is a processor that controls the entire operation of the inspection apparatus 50. The processor 51 is, for example, a central processing unit (CPU). The processor 51 may be, for example, a micro-processing unit (MPU), a graphics processing unit (GPU), an application specific integrated circuit (ASIC), a field programmable gate array (FPGA), etc. The processor 51 may be a single CPU, etc., a plurality of CPUs, etc.

A read-only memory (ROM) 52 is a non-volatile memory. The ROM 52 stores an activation program, etc., of the inspection apparatus 50. A random access memory (RAM) 53 is a volatile memory. The RAM 53 is used as, for example, a working memory during processing at the processor 51.

The storage 54 is, for example, a storage such as a hard disk drive or a solid-state drive. The storage 54 stores various types of programs executed by the processor 51, such as an inspection program.

The input interface 55 includes input devices such as a touch panel, a keyboard, and a mouse. When an operation of an input device of the input interface 55 is performed, a signal corresponding to the operation matter is input to the processor 51. The processor 51 performs various types of processing in response to this signal.

The communication device 56 is a communication device that allows the inspection apparatus 50 to communicate with external devices such as the encoder 30 and the image sensor 40. The communication device 56 may be a communication for either wired or wireless communication devices.

The display 57 is a display such as a liquid crystal display or an organic EL display. The display 57 displays various images. The display 57 may be provided separately from the inspection apparatus 50.

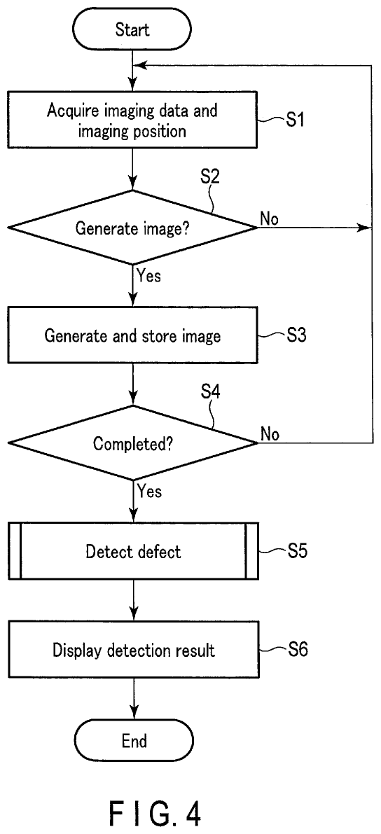

FIG. 4 is a flowchart illustrating an operation of the inspection apparatus 50. The operation illustrated in FIG. 4 is implemented by the processor 51. During the operation illustrated in FIG. 4, the electrode sheet 10 is conveyed by the rollers 10a and 10b. The encoder 30 detects the rotation amount of the roller 10b every a certain period, and outputs the detected rotation amount to the inspection apparatus 50 as a conveyance amount of the electrode sheet 10. The image sensor 40 also performs imaging in synchronization with the conveyance of the electrode sheet 10 and outputs the imaging data to the inspection apparatus 50.

In step S1, the processor 51 computes the imaging position of the image sensor 40 based on the conveyance amount of the electrode sheet 10 obtained from the encoder 30. The imaging position is a position of the electrode sheet 10 imaged by the image sensor 40. If the length of the manufactured electrode sheet 10 is fixed and the conveyance speed of the rollers 10a and 10b are constant, the imaging position of the image sensor 40 can be computed from the conveyance amount. The processor 51 acquires imaging data from the image sensor 40 and stores the acquired imaging data and the computed imaging position in, for example, the RAM 53 in such a manner as to associate them with each other.

In step S2, the processor 51 determines whether or not to generate an image from the imaging data. For example, it is determined to generate an image when imaging data having a sufficient number of lines to form an image is stored in the RAM 53. The number of lines needed for an image to be formed is determined, for example, according to a screen size of the display 57. When it is not determined that an image is to be generated in step S2, the process returns to step S1. In this case, the processor 51 continues to acquire the imaging data and the imaging position. When it is determined that an image is to be generated in step S2, the process proceeds to step S3.

In step S3, the processor 51 generates an image by combining imaging data of each line. The processor 51 stores the generated image in, for example, the storage 54.

In step S4, the processor 51 determines whether or not the imaging of the electrode sheet 10 has been completed. For example, when the conveyance amount exceeds a threshold, it is determined that the imaging of the electrode sheet 10 has been completed. When it is not determined that the imaging of the electrode sheet 10 has been completed in step S4, the process returns to step S1. When it is determined that the imaging of the electrode sheet 10 has been completed in step S4, the process proceeds to step S5.

In step S5, the processor 51 performs defect detection processing (inspection processing). In the other words, the processor 51 is an inspection processor in this embodiment to perform the inspection processing such as the defect detection processing. The defect detection processing is processing of detecting a defect in the fiber layer 13 of the electrode sheet 10 from the image. After the defect detection processing, the process proceeds to step S6. The defect detection processing will be detailed later.

In step S6, the processor 51 displays the result of the detection of a defect on the display 57. The processor 51 then terminates the process illustrated in FIG. 4. For example, the processor 51 displays an image showing detection of a defect in the fiber layer 13 on the display 57. The processor 51 may highlight the position of the defect or further display information on the defect such as the number of defects.

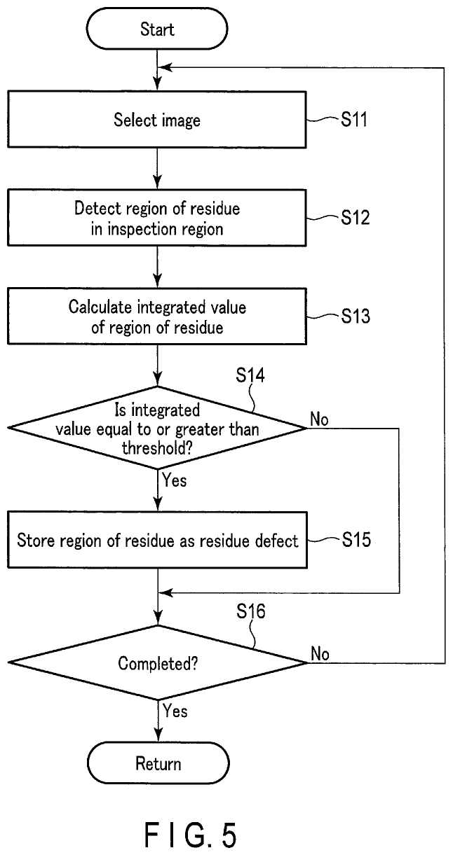

FIG. 5 is a flowchart illustrating the defect detection processing according to the embodiment. In the embodiment, a residue defect is detected as a defect of the fiber layer 13. The residue defect is a defect generated as a result of an excess of organic material used when forming the fiber layer 13 remaining on (the surface of) the negative electrode current collector 12a.

In step S11, the processor 51 selects a single image from the images stored in the storage 54. For example, the processor 51 selects an image in the order in which the images were stored in the storage 54.

In step S12, the processor 51 sets an inspection region and detects a region of the residue of the organic material in the inspection region. In this embodiment, processor 51 is also a detector configured to detect a color in data of the image generated in the imaging of the electrode sheet 10. Alternatively, the detector can be separately provided with processor 51. For clarity, the scope of the invention includes an embodiment where the detector and the inspection processor are in processor 51, namely, the detector and the inspection processor are configured as one element, such as processor 51 in FIG. 3.

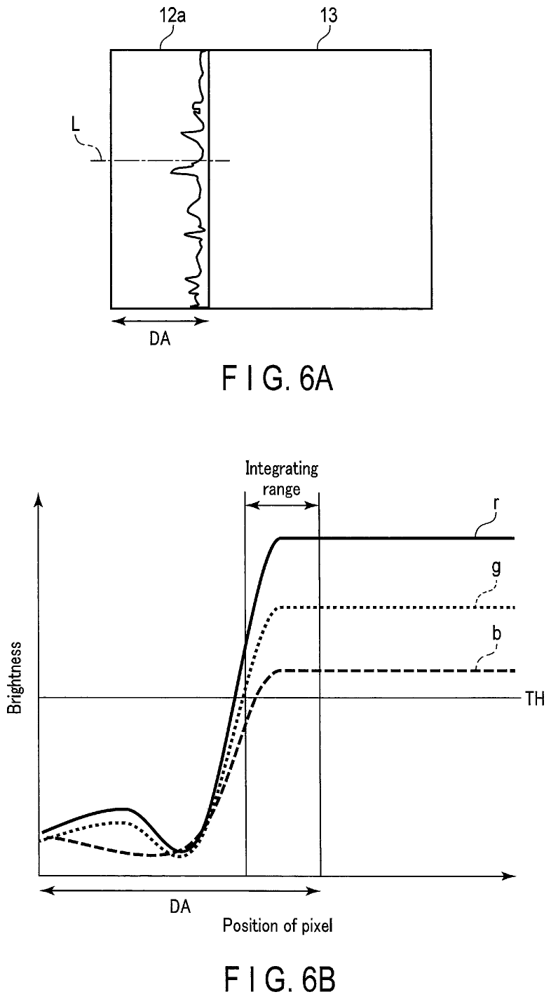

The processing of step S12 will be described. FIG. 6A is a diagram showing the inspection region. As shown in FIG. 6A, an inspection region DA is a region of the negative electrode current collector 12a excluding the fiber layer 13, and is set in an image in the present embodiment. If the negative electrode current collector 12a and the fiber layer 13 are produced without an error in the production stage of the electrode sheet 10, the starting position of the inspection region DA in the width direction is the position of the edge of the negative electrode current collector 12a, and the ending position of the inspection region DA in the width direction is the position of the edge of the fiber layer 13. These positions can be obtained, for example, as a design value. In an actual case, some degree of margin may be included in the starting and ending positions of the inspection region DA in the width direction in consideration of an error in the production of the negative electrode current collector 12a and the fiber layer 13.

In FIG. 6A, it is assumed that there is a residue in the negative electrode current collector 12a. In this case, when the negative electrode current collector 12a is observed from above, a residue of the organic material can be seen when the fiber layer 13 is formed on the negative electrode current collector 12a. FIG. 6B is a graph of the value of the brightness along the line L shown in FIG. 6A. In FIG. 6B, the horizontal axis represents the position of the pixels along the line L, and the vertical axis represents the value of the brightness. The point of origin in the horizontal axis in FIG. 6B is set in a position of the edge of the negative electrode current collector 12a, that is, the starting position of the inspection region DA. Graph r is a graph of the value of the brightness of the sub-pixel R, graph g is a graph of the value of the brightness of the sub-pixel G, and graph b is a graph of the value of the brightness of the sub-pixel B.

In FIG. 6B, all of the values of the brightness of the pixel R, pixel G, and pixel B are low values in the position of the pixel of the left edge of the inspection region DA. This shows the color of the negative electrode current collector 12a. On the other hand, in the positions of the pixels in the inspection region DA, the values of the brightness of the pixel R and the pixel G are drastically higher than the value of the brightness of the pixel B. Namely, the color of the pixels is an approximately yellow color. This is the color of the organic material used in the production of the fiber layer 13.

When there is a residue of the organic material in the negative electrode current collector 12a, as described above, a color change occurs on the image. Therefore, the processor 51 detects, as a region of the residue, a yellow region unique to the fiber layer 13 formed, particularly by the electrospinning method in the present embodiment, directly on the negative electrode 12 as the region having the color of the organic material (an organic-material color) in the inspection region DA. The yellow region in the inspection region DA is, for example, a region in which the value of the brightness of the pixel R and the value of the brightness of the pixel G are equal to or greater than a threshold TH. The processor 51 detects, as the region of the residue, the region in which the value of the brightness of the pixel R and the value of the brightness of the pixel G are equal to or greater than a threshold TH while scanning the image line by line, for example. The thresholds TH of the value of the brightness of the pixel R and the value of the brightness of the pixel G may be the same value or different values. That is, in the present embodiment, the processor 51 detects, as the region of the residue, the region having the color of the organic material in the inspection region DA (in the present embodiment, the color of said region is yellow but is not limited thereto) based on the brightness of the three sub-pixels of the pixel R, pixel G, and pixel B.

Referring back to FIG. 5, a further description will be given. In step S13, the processor 51 calculates an integrated value of the number of pixels of a single image in the region of the residue detected for each line. Namely, the processor 51 calculates an integrated value of the number of pixels of a single image included in the integrating range shown in FIG. 6B. The integrated value represents the area of the region of the residue in the image.

In step S14, the processor 51 determines whether or not the integrated value is equal to or greater than a threshold, for example, whether or not the integrated value is equal to or greater than the number of pixels corresponding to 20% of the inspection region DA. When it is determined that the integrated value is not equal to or greater than a threshold in step S14, the process proceeds to step S16. Namely, in the embodiment, a small amount of residue is not regarded as a defect. When it is determined that the integrated value is equal to or greater than a threshold in step S14, the process proceeds to step S15.

In step S15, the processor 51 stores the position of the region of the residue in the image as the position of the residue defect in the storage 54, for example, in such a manner as to associate it with the image. The process then proceeds to step S16.

In step S16, the processor 51 determines whether or not the processing of detecting the residue defect has been completed for all the images. When it is determined that the processing of detecting the residue defect has not been completed for all the images in step S16, the process returns to step S11. When it is determined that the processing of detecting the residue defect has been completed for all the images in step S16, the processor 51 terminates the process shown in FIG. 5.

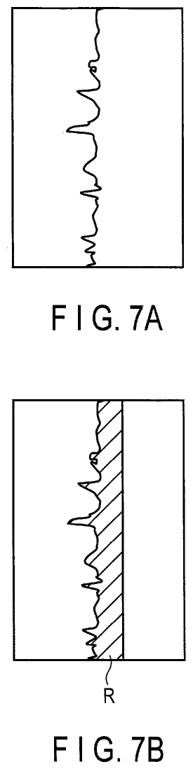

FIGS. 7A and 7B are diagrams showing examples of the display of the residue defect. The display is performed in, for example, step S6 shown in FIG. 4. For example, when the residue defect is detected in the image shown in FIG. 7A, the region R of the residue defect is displayed in a highlighted manner with color, as shown in FIG. 7B. The ordinary image shown in FIG. 7A and the highlighted image of the region of the residue defect shown in FIG. 7B may be displayed side by side. The highlighted display of the region R of the residue defect is not limited to coloring.

As described above, according to the embodiment, the current collector on the electrode sheet can be inspected for the presence or absence of the residue defect of the organic material based on a color change of the image. Namely, in the embodiment, inspection for the presence or absence of the residue defect can be performed with a simple structure in which only the image sensor is used. Also, in the embodiment, the inspection can be performed by putting the electrode sheet into an inspection sheet in the stage where formation of the fiber layer is completed. That is, the inspection can be performed in the production stage.

(Modifications)

In the embodiment described above, the inspection region is set in the negative electrode current collector 12a. On the other hand, the fiber layer 13 may also be formed on the positive electrode active material layer 11b of the positive electrode 11. In this case, the inspection region may be set in the positive electrode current collector 11a.

In the above-described embodiment, the electrode sheet 10 conveyed by the rollers 10a and 10h is imaged by the stationary image sensor 40. In contrast, the position of the electrode sheet 10 may be fixed so that the image sensor 40 can scan the electrode sheet 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An inspection system for a secondary battery, the inspection system comprising:
an image sensor configured to capture an image of an electrode structure of a secondary battery, the electrode structure comprising an electrode and a fiber layer formed on a surface of the electrode, the electrode comprising a current collector and an active material layer;
a detector configured to detect a color in data of the image captured with the image sensor; and
an inspection processor configured to inspect a residue of an organic material in the fiber layer, based on the color detected with the detector.

2. The inspection system for a secondary battery according to claim 1, wherein the inspection processor is configured to:
set a region of the current collector as an inspection region; and
detect, as a region of the residue, a region having an organic-material color of the organic material in the image in the inspection region.

3. The inspection system for a secondary battery according to claim 2, wherein the inspection processor is configured to detect the region having the organic-material color based on a brightness of each of red, green, and blue sub-pixels constituting pixels of the image.

4. The inspection system for a secondary battery according to claim 2, wherein the inspection processor is configured to detect, as the region having the organic-material color, a region in which a value of a brightness of each of red and green sub-pixels of the image in the inspection region is equal to or greater than a threshold.

5. The inspection system for a secondary battery according to claim 2, wherein the inspection processor is configured to detect, as the region of the residue, an area having the organic-material color equal to or greater than a threshold.

6. The inspection system according to claim 1, wherein the image sensor is a line sensor having pixels arrayed along a width direction of the electrode structure.

7. An inspection method for a secondary battery, the method comprising:
capturing an image of an electrode structure of a secondary battery, the electrode structure comprising an electrode and the fiber layer formed on a surface of the electrode, the electrode comprising a current collector and an active material layer;
detecting a color in data of the image; and
inspecting a residue of an organic material in the fiber layer, based on the color detected in the data.
